(19) United States
(12) Patent Application Publication
(10) Pub. No.: US 2012/0097114 A1
(43) Pub. Date: Apr. 26, 2012

(54) Mobile indicia interactive pet toy

(76) Inventor: Douglas Edward Scott, Loveland, CO (US)

(21) Appl. No.: 13/317,526

(22) Filed: Oct. 19, 2011

Related U.S. Application Data
(60) Provisional application No. 61/455,491, filed on Oct. 20, 2010.

(51) Int. Cl. A01K 29/00

(52) U.S. Cl. 119/707

(57) ABSTRACT

A pet toy responsive to sensed motion of a pet to generate and move an indicia on a support surface to provide interactive play.

This United States Non-Provisional patent application claims the benefit of U.S. 61/455,491, filed Oct. 20, 2011, hereby incorporated by reference herein.

### I. BACKGROUND

A pet toy responsive to sensed motion of a pet to generate and move an indicia on a support surface to provide interactive play.

Typically, pet toys remain stationary and movement of the pet toy occurs only in response to direct contact by the pet. Accordingly, the pet plays with the toy but the toy does not interact with the motion of the pet to facilitate play.

The instant invention provides a pet toy and methods using a pet toy which senses movement of pets and generates at least one mobile indicia for interactive play with the pet.

### II. SUMMARY OF THE INVENTION

Accordingly, a broad object of the invention can be to provide a computer implemented apparatus which in response to the sensed motion of external objects generates and moves an indicia on a distal surface.

Another broad object of the invention can be to provide a stationary housing having an external surface configuration suitable for use as a pet toy in which embodiments of the computer implemented apparatus can be housed which in response to motion of pets generates and moves a sensorially perceivable indicia.

Another broad object of the invention can be to provide method of using a computer implemented apparatus to transform sensed motion of pets into steps of generating and moving a sensorially perceivable indicia for interactive play with the pet.

Naturally, further objects of the invention are disclosed throughout other areas of the specification, drawings, photographs, and claims.

### III. A BRIEF DESCRIPTION OF THE DRAWINGS

FIG. 1 is an illustration of a method of using a particular embodiment of an inventive pet toy.

FIG. 2 is a front side view of a particular embodiment of the inventive pet toy shown in FIG. 1.

FIG. 3 is a back side view of the particular embodiment of the inventive pet toy shown in FIG. 1.

FIG. 4 is a top side view of the particular embodiment of the inventive pet toy shown in FIG. 1.

FIG. 5 is a bottom side view of the particular embodiment of the inventive pet toy shown in FIG. 1.

FIG. 6 is a cross section view of the particular embodiment of the inventive pet toy shown in FIG. 1.

FIG. 7 is a top view of an embodiment of an electrical conductor disk used to convey signals and power between a rotating surface and a stationary surface.

FIG. 8 is a side view of an embodiment of an electrical conductor disk used to convey signals and power between a rotating surface and a stationary surface.

FIG. 9 is a block flow diagram of the steps of using the particular embodiment of the pet toy shown in FIG. 1.

### IV. DETAILED DESCRIPTION OF THE PREFERRED EMBODIMENTS

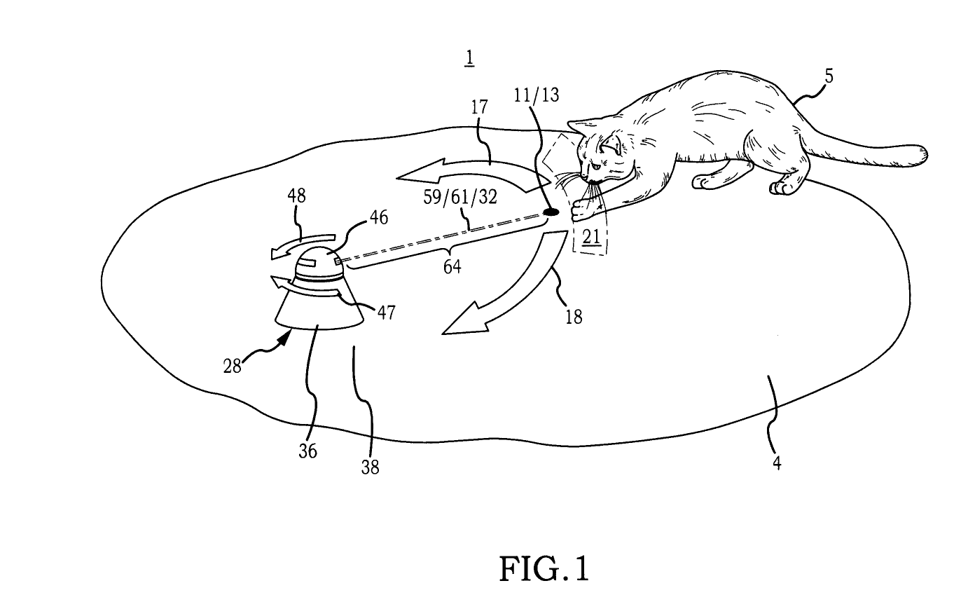

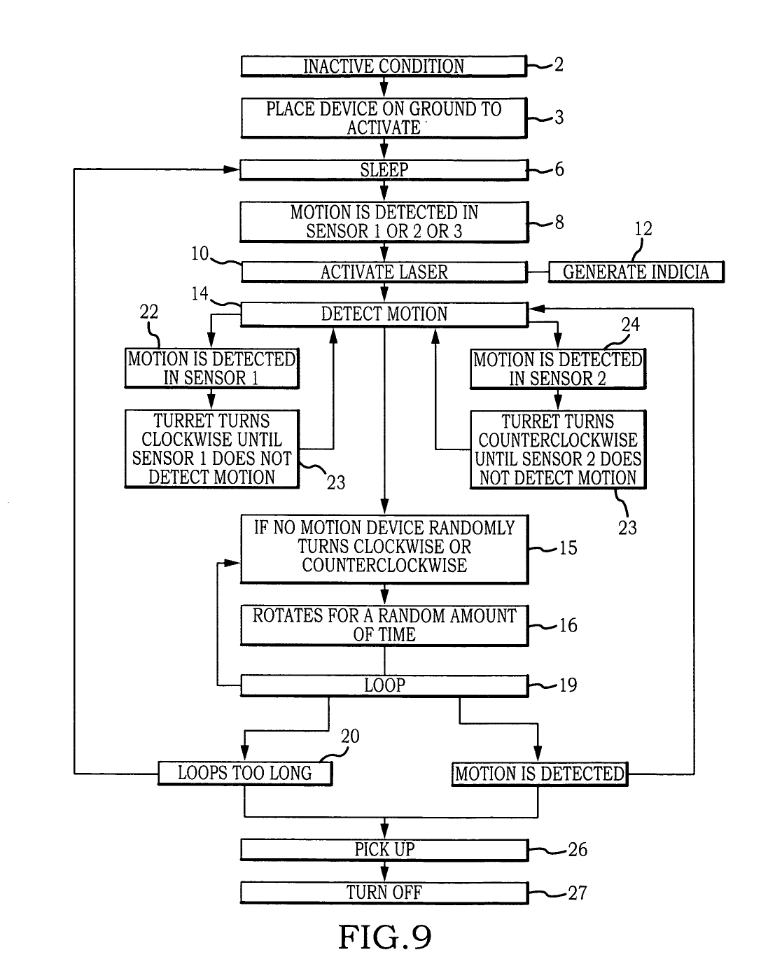

Now referring primarily to FIGS. 1 and 9. FIG. 1 illustrates a particular non-limiting method of using an embodiment of the inventive mobile indicia interactive pet toy (1) (referred to as “pet toy”) and FIG. 9 provides a block flow diagram which provides a schematic illustration of a process of using certain embodiments of the pet toy (1). The steps shown in the block flow diagram of FIG. 9 are not intended to limit the method of using the invention by requiring that all or any portion of the steps be included or are critical in the inventive method or that the steps must be performed in any particular order, unless otherwise indicated in the following description.

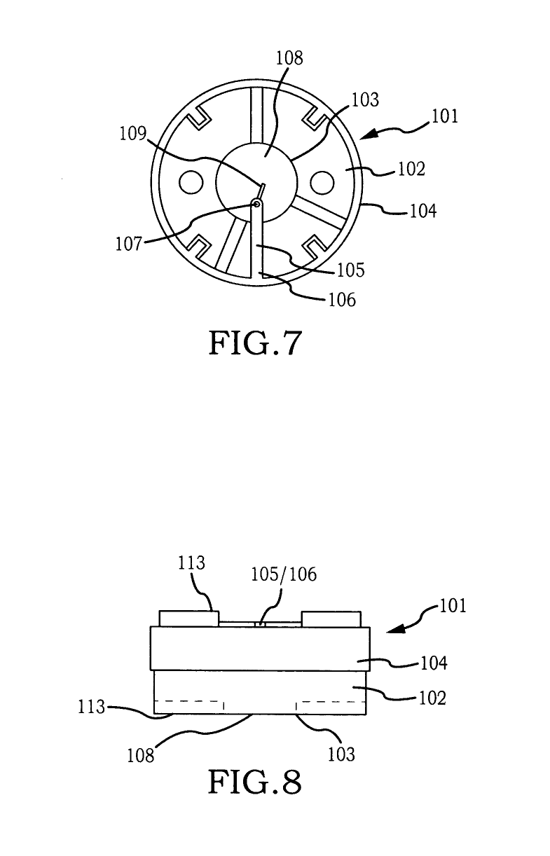

Accordingly, the pet toy (1) can from the inactive condition (block (2) in FIG. 9) be disposed in the active condition (block (3) in FIG. 9) by locating the pet toy (1) on a support surface (4). While FIG. 1 shows the support surface (4) as being a substantially flat surface, the invention is not so limited, and the support surface (4) can be any surface of sufficient area to support a particular embodiment of the pet toy (1) during normal operation. Additionally, while FIG. 1 shows the pet toy (1) located on the same support surface (4) as a pet (5) interacting with the pet toy (1), the invention is not so limited, and the pet toy (1) can be located on a different surface than that of the pet (5). As a non-limiting example, the pet toy (1) can be located on a support surface (4) which is at a different height or is discontiguous from the surface on which the pet (5) has a location, or the like. If the pet toy (1) does not sense any motion, then the pet toy (1) can activate a sleep condition (block (6) in FIG. 7) in which at least one motion sensor (7) remains active. The pet toy (1) upon sensing motion (block (8) in FIG. 7) activates an indicia generator (9) (block (10) in FIG. 9) which generates an indicia (11) (block (12) in FIG. 9) which can be viewed by the pet (5). While FIG. 1 shows the pet (5) as a cat, the invention is not so limited, and the pet (5) can be one pet (5) or a plurality of pets (5) or one or more than one genus, species or breeds. As non-limiting examples, the pet(s) (5) which interact with the pet toy (1) can be dogs, cats, ferrets, rodents, birds, or the like. Additionally, while the embodiment of the invention shown by FIG. 1, shows the indicia (11) as a laser spot (13) incident on the support surface (4), the invention is not so limited and the indicia (11) can be any manner of indicia (11) which can be disposed at a distance from the pet toy (1) viewable by or interactive with the pet (5).

The pet toy (1) can then commence a waiting period having a pre-determined period of time (block (14) in FIG. 9). If during the waiting period (14), the pet toy (1) does not sense motion of the pet (5), then the pet toy (1) can move the location of the indicia (11) on the support surface (4) (block (15) in FIG. 97). Movement of the indicia (11) on the support surface (4) can continue for a period of time (block (16) in FIG. 9). As to certain embodiments of the invention, the indicia (11) can travel about the pet toy (1) in a first direction (17) such as clockwise or counterclockwise and if no movement is sensed in the period of time then the pet toy (1) can randomly select the same first direction (17) of movement or a second direction (18) of movement during the period of time (block (16) in FIG. 9). The pet toy (1) can loop (block (19) in FIG. 9) through blocks (15)(16) for a predetermined number of loops (block (20) in FIG. 9) and after the predetermined number of loops elapse without sensing motion of the pet (5), the pet toy (1) can return to the sleep condition (block (6) in FIG. 9).

Alternately, if the pet toy (1) senses motion of the pet (5) in a first sensed field (21) (block (22) in FIG. 9), the pet toy (1) moves the first sensed field (21) until motion of the pet (5) is no longer sensed (block (23) in FIG. 9). The pet toy (1) returns to the waiting condition (block (14) in FIG. 9). Again, in those embodiments of the pet toy (1) having more than a first sensed field (21), the pet toy (1) can upon sensing motion in a second sensed field (24a) (or any other sensed field) (block (24) in FIG. 9), move the second sensed field (24a) (or any sensed field) until motion of the pet is no longer sensed (block (25) in FIG. 7). The pet toy (1) returns to the waiting condition (block (14) in FIG. 9). The pet toy (1) then returns to block (15) in FIG. 9, if no motion is sensed for a period of time.

The pet toy (1) can at any time be disengaged from the support surface (4) (block (26) in FIG. 9). Relocation of the pet toy (1) to a different location on the support surface (4) returns the pet toy (1) to the active condition (block (3) in FIG. 9). Alternately, the pet toy (1) can be disposed in the inactive condition (block (27) in FIG. 9).

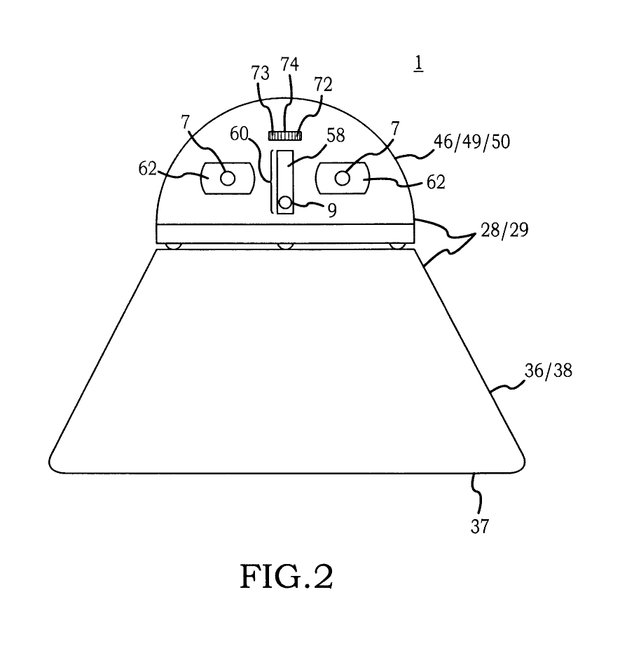

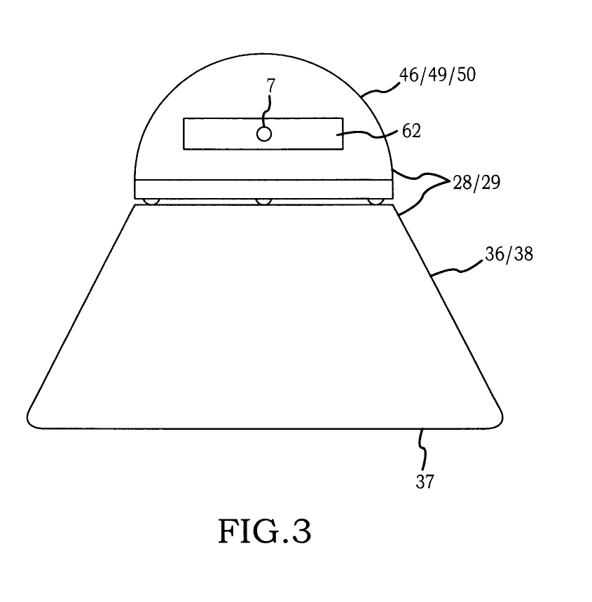

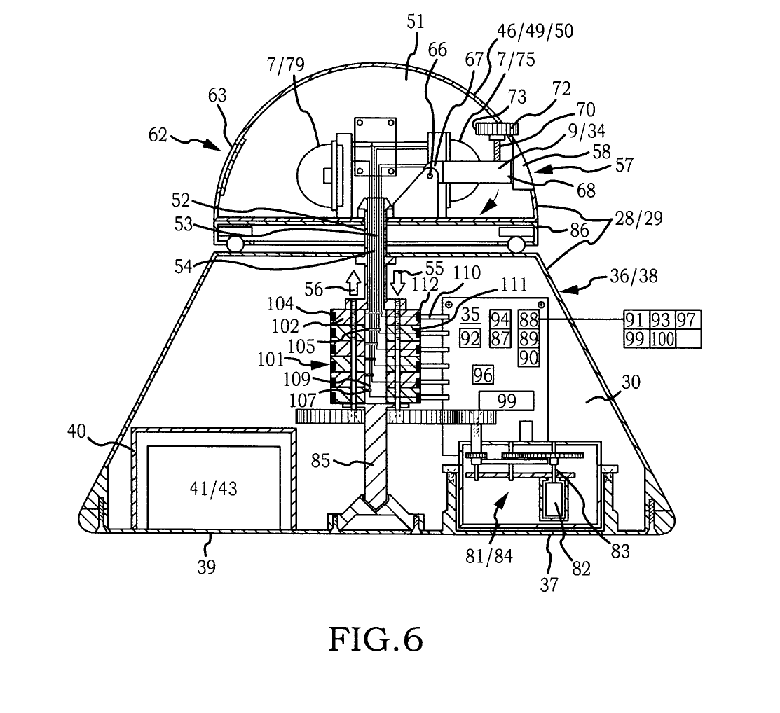

Now referring primarily to FIGS. 2 and 3, embodiments of the invention can include a housing (28). The housing (28) can define the configuration of a base housing portion external surface (29) of the pet toy (1) and provides sufficient base portion inside space (30) (see for example FIG. 6) to house various components of the inventive pet toy (1) such as a power source (41), motion sensors (7), indicia movement generator (33), indicia generator (9), a controller (35), or the like. Certain embodiments of the pet toy (1) can provide one piece housing (28) while other embodiments of the inventive pet toy (1) can provide a housing (28) assembled from two or more pieces (whether in fixed or movable relation). The non-liming embodiment of the pet toy (1) as shown in FIGS. 2 (front view) and 3 (rear view) provides a two piece housing (28) including a base housing portion (36) having a bottom (37) (shown also in FIG. 5) and side walls (38). In the non-limiting embodiment shown in the Figures, the side walls (38) taper inwardly to provide a base housing portion (36) in the form of a truncated cone; however, the invention is not so limited and the housing (28) can be of any external configuration which affords sufficient inside space (30) to house the components further described below.

Now referring primarily to FIG. 5, the bottom (37) of the base housing portion (36) can have a substantially planar external surface (although other configurations which allow the bottom to engage the support surface (4) can be utilized) can be removably engaged with a support surface (4) at a location (4a), as above described. The bottom (37) can further provide a power source access cover (39). The power source access cover (39) can be of any constructional form which allows access to a power source holder (40) and the power source (41). As a non-limiting example, the power source access cover (39) can be a cover removably fitted to an access aperture (42). The power source access cover can be removable fitted to an access aperture element (42) by mechanical fasteners, by a hinge and latch, or one or more detents depending on the constructional form. The power source holder (40) can be configured to receive a power source (41) which as to certain embodiments can be one or a plurality of batteries (43). However, the invention is not so limited and the power source (41) could also include alternating current converted to direct current, or the like.

The bottom (37) of the base housing portion (36) can further provide a support surface sensor receptacle (44) (shown in FIG. 5 as a closed end enclosure) configured to fix a support surface sensor (45) at a location which allows the support surface sensor (45) to sense engagement of the bottom (37) of the base housing portion (36) (or the housing (28)) with the support surface (4).

Again referring primarily to FIGS. 2 and 3, in those embodiments having a two piece housing (28), an upper housing portion (46) can be rotatably coupled to the base housing portion (36) to allow the upper housing portion (46) to rotate in relation to the base housing portion (36). Rotation of the upper housing portion (46) in relation to the base housing portion (36) can be in the clockwise direction (47) or counterclockwise direction (48) (see for example FIG. 1) or alternate between the clockwise direction (47) and the counterclockwise direction (48), as further described below. The upper housing portion (46) can have upper portion side walls (49) which define the configuration of the upper portion external surface (50) an upper housing inside space (51) sufficient in volume to house motion sensors (7) and the indicia generator (9), as further described below. As shown in the Figures, certain non-limiting embodiments of the upper housing portion (46) can have an upper portion external surface (50) of substantially hemispherical configuration rotatably coupled to the base housing portion (36). However, the configuration of the upper portion external surface (50) is not so limited and the upper portion external surface (50) of the upper housing portion (46) can have any manner of configuration suitable for enclosing a sufficient upper housing inside space (51) to accommodate the motion sensors (7) and indicia generator (9) along with the associated circuitry. The base portion inside space (30) of the base housing portion (36) and the upper portion inside space (51) of the upper housing portion (46) can communicate through at least an electrical conduit (52) which provides a passage (53) through which electrical circuitry (54) passes for the transmission of power from the power source (41), sensor signals (55) to the controller (35), control signals (56) from the controller (35) to motion sensors (7), the indicia generator (9), or the like.

Now referring primarily to FIG. 2, the front side (57) of the upper housing portion (46) can further provide a light beam aperture (58) through which a light beam (59) (for example as shown in FIG. 1) produced by the indicia generator (9) can pass (or a light beam window of sufficiently transparent material to allow the transmission of the light beam (59) and generation of the indicia (11) on the support surface (4)). The light beam aperture (58) can have dimensional relations corresponding to the range of adjustment (60) of the light beam path (61).

Again referring primarily to FIG. 2, the front side (57) of the upper housing portion (46) can further include one or more than one sensor aperture(s) (63) (or sensor windows sufficiently transparent to allow the sensor(s) (7) to detect movement in relation to the pet toy (1). Similarly, as shown by FIG. 3, the back side (62) of the upper housing portion (46) can provide one or more than one sensor aperture(s) (63) (or sensor windows sufficiently transparent to allow the sensor(s) (7) to detect movement in relation to the pet toy (1)).

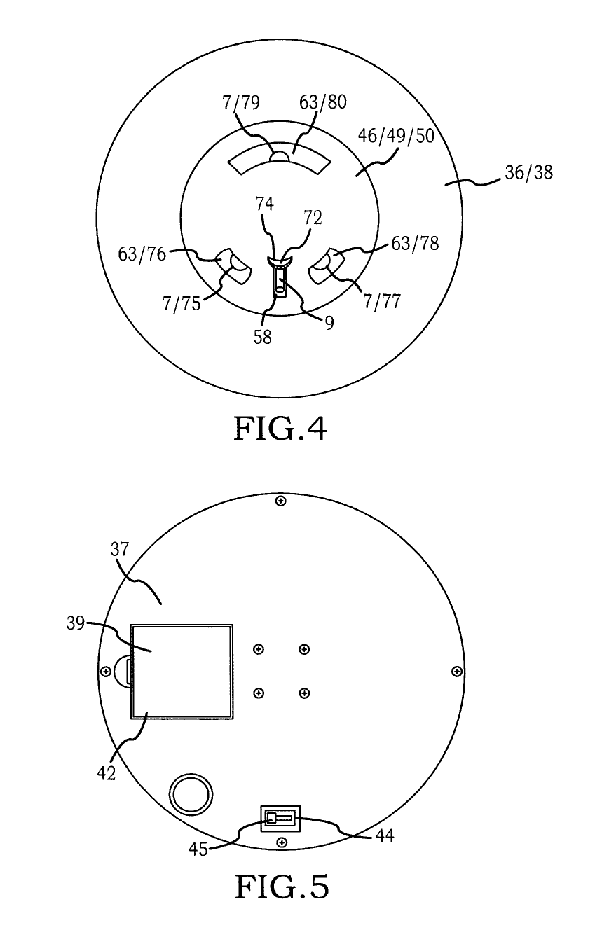

Now referring primarily to FIG. 4, the top view of a particular non-limiting embodiment of the pet toy (1) shows the dimensional relations of the light beam aperture (58) and a pair of sensor apertures (63) on the front of the upper housing portion (46) and a single sensor aperture (63) on the backside (62) of the upper housing portion (46); however, the dimensional relations of each of the light beam aperture(s) (58) and sensor apertures (63) and the dimensional relations between them can vary depending to the external surface (29) (50) configuration of the pet toy (1) and the light beam aperture (58) and the sensor apertures (63) can be of a configuration which allows the inventive pet toy (1) to operate in accordance with the one or more to of the steps of the method above described.

Now referring primarily to FIG. 6, which provides a cross section view of the non-limiting embodiment of the inventive pet toy (1) shown in FIGS. 1-5. The indicia generator (9) can be mounted within the upper portion inside space (51) to allow the light beam(s) (59) to directly (or indirectly by way of light beam splitters or reflective surfaces) to pass through the light beam aperture(s) (58). As to certain embodiments, the indicia generator (9) can be mounted in stationary relation to the upper portion side walls (49) defining the volume of the upper portion inside space (51). As to certain embodiments, the light beam path (61) can be altered by positionally adjustable movement of reflective surfaces, and as to other embodiments, the indicia generator (9) can have a range of movement (60) whether in relation to the reflective surfaces or light beam aperture (58). In those embodiments of the pet toy (1) which have a rotatable upper housing portion (46), rotation of the upper housing portion (46) can correspondingly alter the direction of light beam path (61) radially about the external surface (29) of the pet toy (1) (whether rotation is clockwise (47) or counterclockwise (48)). The indicia generator (9) can further be incrementally adjustable to fix the indicia (11) (also referred to as the “light beam spot” or the “laser spot”) at a greater or lesser distance (64) (see for example FIG. 1) from the external surface (29) of the pet toy (1) by an indicia generator adjustment element (65), as further described below.

A particular embodiment of the pet toy (1) can provide the indicia generator (9) in the form of a laser (34). The laser (34) can have a power of less than 5 milliwatts (5 mW) yet be capable of projecting a laser beam (32) which incident upon a support surface (4) produces the indicia (11) in a the form of a laser spot (13) of colored light. Such a laser beam (32) may not be visible from the side, but may be visible as a result of light scattered by dust particles along the light beam path (59). The width of the laser beam (32) and low power of the laser (34) may make the laser beam (32) invisible in a reasonably clean atmosphere, showing only an indicia (11) or laser spot (13) of light when striking an opaque surface. The recent low-cost availability of infrared (IR) diode laser modules of up to 1000 mW (1 watt) output has created a generation of IR-pumped frequency-doubled laser light beams in green, blue, and violet, of visible power (100-300 mW) which can be utilized in embodiments of the pet toy (1). The light beam (59) while described in the instant embodiment as a laser beam (32) is not so limited and any manner of generating a narrow projection of light energy such as an incandescent lamp or light emitting diode which in certain embodiments be focused with a parabolic reflector could also be utilized.

The laser (34) shown in FIG. 6 can have a tubular profile rotatably coupled to a pivot element (66) proximate the first end (67) (the end distal from the second end (68) which emits the laser beam (32)). An indicia generator adjustment element (69) can include a spirally threaded member (70) which upon rotation acts on a body (71) of the indicia generator (9)(34) having a length disposed between the first end (67) and the second end (68) to positionally adjust the second end (68) of the indicia generator (9)(34) by rotation of the body of the indicia generator (9)(34) about the pivot element (66). The spirally threaded member (70) can for example be part of a thumbscrew having a cylindrical head (72) with ridged, knurled, or dimpled cylinder sides (73). The indicia generator adjustment element (69) (thumbscrew) can have a fixed location in the upper portion inside space (51) allowing a portion of the cylindrical head (72) to project through a corresponding indicia generator adjustment element aperture (74) (see also FIG. 4). By forcible urging upon the projecting portion of the cylindrical head (72) the spirally threaded member (70) can be rotated to positionally adjust the body (71) of the indicia generator (9)(34) to correspondingly alter the light beam path (61) of the light beam (59)(32). The adjustment range of the light beam path (61) can depend upon the configuration of the pet toy (1). As to the embodiment of the pet toy (1) shown in the Figures, the adjustment of the light beam path (61) places the indicia (11) (such as the laser spot (13) generated by a laser beam (32)) at a lesser or greater distance (64) from the external surface (29) of the pet toy (1). The indicia (11) (or spot generated by incidence of the laser beam (32) on the support surface (4)) can then be further moved by rotation of the upper housing portion (46) to which the indicia generator (9) can be mounted.

Again referring to FIG. 6, each motion sensor (7) can have a fixed location within the upper portion inside space (51) in relation to a corresponding sensor aperture (62) suitable for the detection of motion about the pet toy (1) in a first sensed field (21). While the embodiment of the pet toy (1) shown in FIG. 6, shows a first motion sensor (7)(75) in operational relation to a first sensor aperture (62)(76) having a first detection field (21) directed to the front side (57) of the upper housing portion (46) and a second motion sensor (7)(77) in operational relation to a second sensor aperture (63)(78) on opposed sides of the light beam aperture (58) and a third motion sensor (7)(79) in operational relation to a third sensor aperture (63)(80) having a location on the back side (62); the invention is not so limited and the inventive pet toy (1) can include a greater or lesser number of motion sensors (7) or motion sensors (7) sufficient in number to allow detection of motion of a pet (5) about the indicia (11)(13) on the support surface (4). A motion sensor suitable for use with embodiments of the invention can be passive infrared motion sensor module (as a non-limiting example, a PIR Motion Sensor Module, PN MS-360 available from IR-Tec International Ltd.). Understandably, motion can be detected by measuring change in speed or vector of objects in the detection field, or by sound, opacity, geomagnetism, reflection of transmitted energy (ultrasonic, microwave, infrared), vibration, electromagnetic induction, or the like. Accordingly, depending on the application numerous and varied motion sensors can be utilized.

Again referring primarily to FIG. 6, an indicia movement generator (33) can alter the position of the indicia (11)(13) on the support surface (4) about the pet toy (4). The indicia movement generator (33) can take the form of the upper housing portion (46) rotated either clockwise (47) or counterclockwise (48) or alternatingly clockwise (47) or counterclockwise (47) in relation to the base housing portion (36), as above described, to correspondingly positionally locate the indicia generator (9)(34).

Rotation of the upper housing portion (46) can be achieved by direct or indirect engagement with a transmission means (81) coupled to a motor (82). In certain embodiments, a ring gear (not shown) can be coupled to the base housing portion (36) of the pet toy (1). The motor can be fixed at a location in the upper housing portion (46) to provide a motor shaft (83) having a gear which projects through a slot which allows mated engagement of teeth of the gear and the ring gear. Rotation of the motor shaft (83) drives the gear about the ring gear to correspondingly drive the upper housing portion (46) in clockwise (47) or counterclockwise (48) rotation.

As to the embodiment of the indicia movement generator (33) shown in FIG. 6, the motor (82) can be a reversible direction motor which can be fixedly mounted in the base housing portion (36). The transmission means (81) can include a gear box (84) driven by the motor (82). In turn, the gearbox (84) can rotationally drive by toothed, belt, frictional, or other mated engagement a vertical shaft (85) rotationally journaled within the base housing portion (36). Some embodiments may avoid the use of the gearbox by toothed, belt, frictional or other mated engagement of the motor shaft (83) with the vertical shaft (85). A first end (86) of the vertical shaft (85) can project beyond the base housing portion (36) and connect to the upper housing portion (46) substantially on center. Rotation of the vertical shaft (85) correspondingly drives the upper housing portion (46) in a clockwise (47) or counterclockwise (48) direction.

Again referring to FIG. 6, embodiments of the invention can further include a power source (41) which can take the form of direct current as produced by batteries (43), alternating current, alternating current converted to direct current, or the like depending on the application.

Again referring primarily to FIG. 6, embodiments of the invention can further include a controller (35). In part, the controller (35) can include a processer (87) and at least one memory element (88). The function of the processor (87), regardless of the physical form, can be to execute the instructions of the program (89) stored in the memory element (88). The program (89) has program modules (90) each of which function to control the various components of the pet toy (1) to perform one, a part of one, more than one or all of the operational steps of the cat toy (1) set out in FIG. 9.

Accordingly, a support surface sensor (45) generates an analog signal upon location of the bottom (39) of the pet toy (1) on a support surface (4). The analog signal representing the sensed location (38) of the bottom (39) of the pet toy (1) in relation to the support surface (4) can be converted to a digital signal representation by an analog to digital converter (96) and received by the processor element (87). The processor element (87) executing a power regulation module (91) of the program (89) which in turn activates a power regulation element (92) functions to control power to the motion sensors (7), indicia generator (9), indicia movement generator (33) and to the processor element (87), memory elements (88), and the like.

The program (89) can further provide an activity mode module (93) which functions to place the pet toy (1) in the inactive condition (block (2) in FIG. 9) when the pet toy (1) is removed from the support surface (4), in the sleep condition (block (6) in FIG. 9) when the bottom (39) of the pet toy (1) is located (38) on a support surface (4), and in waiting condition (block (14)) or the sleep condition (block (6) in FIG. 9) based upon sensed motion or a lack of sensed motion about the pet toy (1).

The processor element (87) can further provide a timer element (94) which allows a timer module (95) of the program (89) to time the delivery of instructions of the program (89) in response to sensed motion or location (38) of the bottom of the pet toy (1) in relation to the support surface (4).

Motion of pets (5) about the pet toy (1) can be sensed by any one of the motion sensors (7)(75)(77)(79). The motion sensors (7) can produce an analog signal which represents sensed motion of the pets (5). The analog signal representation of sensed motion can be converted by an analog to digital converter (96) to a digital representation of the sensed motion of which can be received by the processor element (87) and operated on by the motion sensor module (97) of the program (89) to activate the indicia generator module (98) of the program (89) which functions to operate the indicia generator (9) between the on condition to produce the light beam (59) which produces the indicia (11)(13) on the support surface (4) and the off condition. Subsequent motion sensed by the first motion sensor (75) or the second motion sensor (77) or the lack of motion for a period of time activates the indicia movement module (99). The indicia movement module (99) functions to control the movement of the indicia (11) on the support surface whether by control of the motor (82) through a motor driver element (113) and transmission means (81) to rotate the upper housing portion either clockwise (47) or counterclockwise (48), or adjust the alignment of reflective surfaces (not shown) which control the light beam path (61) to correspondingly alter the location of the indicia (11) on the support surface (4) to provide the corresponding steps (or portions of steps) set out in FIG. 7.

The program (89) can further include a loop module (100) which functions with the timer module (95) to time the duration of certain steps in correspondence with the signals generated by the motion sensors (7) to return to and operate prior steps in the program (89).

Now referring primarily to FIGS. 6-8, with respect to embodiments of the pet toy (1) which have a housing (28) in portions that rotate in relation to each other and provide electrical circuitry (54) in the form of individual wires which communicates between housing portions (36)(46) for the transmission of power and signals, one or a plurality of electrical conductor disk(s) (101) (for example as shown in FIGS. 7 and 8) can be utilized to transfer electrical power and signals between the rotated electrical circuitry (54) and a stationary controller (35) (or controller board) or other stationary component. Each of the plurality of electrical conductor disk(s) (101) can provide a substantially cylindrical or annular insulator body (102) having a thickness disposed between opposed substantially circular faces (113). In the embodiment of the pet toy (1) shown in FIG. 6, an annular insulator body (102) has a conductor disk aperture (103) through which the vertical shaft (85) passes. The annular insulator body (102) can be rotationally fixed about or comprise a portion of the vertical shaft (85) such that rotation of the vertical shaft (85) generates corresponding rotation in the annular insulator body (102). An annular conductor element (104) can be fixedly coupled to the external surface of the insulator body (102) to rotate with the annular insulator body (102). An electrically conductive terminal element (105) having a first end (106) connected to the annular conductor element (103) projects radially inward to locate the second end (107) within the open area (108) defined by the disk aperture which allows the second end (108) to receive or contact or connect with a conductor (109) which carries power or electrical signals. An electrically conductive contact element (110) can have a length disposed between a stationary end (111) and a contact end (112). The contact end (112) can travel on the external surface of the annular conductor element (104) to transmit power an signals from the controller (35). As shown in FIG. 6 a plurality of electrical conductor disks (101) can be stacked face (113) to face (113) to provide the number of circuits required to carry power and signals to and from the controller (35).

As can be easily understood from the foregoing, the basic concepts of the present invention may be embodied in a variety of ways. The invention involves numerous and varied embodiments of a mobile indicia interactive cat toy and methods of making and using the mobile indicia interactive cat toy including the best modes.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “a mobile indicia” should be understood to encompass disclosure of the act of “moving an indicia”—whether explicitly discussed or not—and, conversely, were there effectively disclosure of the act of “moving an indicia”, such a disclosure should be understood to encompass disclosure of “a mobile indicia” and even a “means for moving and indicia.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Moreover, for the purposes of the present invention, the term “a” or “an” entity refers to one or more of that entity; for example, “a laser” refers to one or more of those elements or at least one element. As such, the terms “a” or “an”, “one or more” and “at least one” can be used interchangeably herein. Furthermore, an element “selected from the group consisting of” refers to one or more of the elements in the list that follows, including combinations of two or more of the elements.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result.

Thus, the applicant(s) should be understood to claim at least: i) each of the mobile indicia interactive pet toys herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. An apparatus, comprising:
a) at least one motion sensor;
b) an indicia generator capable of producing a sensorially perceivable indicia on a support surface;
c) a indicia movement generator; and
d) a controller which activates said indicia generator and said indicia movement generator in response to sensed motion of an object by said at least one motion sensor.

2. The apparatus of claim 1, wherein said controller activates said indicia movement generator upon elapse of a period of time in the absence of sensed motion of said object.

3. The apparatus of claim 2, wherein said controller activates said indicia movement generator to generate travel of said sensorially perceivable indicia on said support surface in a first direction.

4. The apparatus of claim 4, wherein said controller actives said indicia movement generator to generate travel of said sensorially perceivable indicia on said support surface in a second direction in the absence of sensed motion of said object during travel of said sensorially perceivable indicia in said first direction.

5. The apparatus of claim 4, wherein said at least one sensor senses a first sensed field.

6. The apparatus of claim 5, wherein said controller moves the location of said first sensed field upon sensed motion of said object.

8. The apparatus of claim 6, wherein said controller actives said indicia movement generator to generate travel of said sensorially perceivable indicia on said support surface in said first direction in the absence of sensed motion of said object in said first sensed field.

9. The apparatus of claim 8, wherein said controller actives said indicia movement generator to generate travel of said sensorially perceivable indicia on said support surface in a second direction in the absence of sensed motion of said object during travel of said sensorially perceivable indicia in said first direction.

10. The apparatus of claim 5, wherein said at least one sensor senses a second sensed field.

11. The apparatus of claim 10, wherein said controller moves the location of said second sensed field upon sensed motion of said object in said second sensed field.

12. The apparatus of claim 11, wherein said controller actives said indicia movement generator to generate travel of said sensorially perceivable indicia on said support surface in a first direction in the absence of sensed motion of said object in said second sensed field.

13. The apparatus of claim 12, wherein said controller actives said indicia movement generator to generate travel of said sensorially perceivable indicia on said support surface in a second direction in the absence of sensed motion of said object during travel of said sensorially perceivable indicia in said first direction.

14. The apparatus of claim 13, wherein said controller activates said indicia movement generator to generate travel of said sensorially perceivable indicia on said support surface a greater or lesser distance in relation to the external surface of said apparatus.

15. The apparatus of claim 1, wherein said at least one motion sensor further senses placement of said apparatus on said support surface, and wherein said controller activates said apparatus.

16. The apparatus of claim 1, wherein said object comprises an animal.

17. The apparatus of claim 16, wherein said animal comprises a cat.
